(19) United States
(12) Patent Application Publication
(10) Pub. No.: US 2013/0265769 A1
(43) Pub. Date: Oct. 10, 2013

(54) EVEN PRESSURE DISTRIBUTION LED ILLUMINATION DEVICE

(71) Applicant: James Steedly, Manifee, CA (US)

(72) Inventor: James Steedly, Manifee, CA (US)

(73) Assignee: Maxlite, Inc., West Caldwell, NJ (US)

(21) Appl. No.: 13/442,025

(22) Filed: Apr. 9, 2012

(51) Int. Cl. F21V 29/00

(52) U.S. Cl. 362/294

(57) ABSTRACT

A light emitting diode (“LED”) illumination device includes a substantially rigid reflector cover having a plurality of open air reflectors, a circuit board having a plurality of LED packages and a plurality of thermal vias disposed in the circuit board in the vicinity of each LED package thereby defining a pressure zone, and a mounting bracket that functions as a heat sink The base of each open air reflector is dimensioned to cover at least a portion of the pressure zone. Fasteners are used to mechanically couple the reflector cover to the circuit board and the mounting bracket and to create pressure on the thermal vias in the pressure zone. In operation, heat created from operation of the LED illumination device is effectively dissipated into the atmosphere and is simultaneously pulled away from the LED packages through the plurality of thermal vias to the mounting bracket.

### FIELD OF THE INVENTION

The present disclosure generally relates to illumination devices and, more particularly, to light emitting diode (“LED”) based illumination devices.

### BACKGROUND OF THE INVENTION

Most lighting applications utilize incandescent or gas-filled bulbs, particularly lighting applications that require more than a low level of illumination. Incandescent bulbs typically do not have long operating lifetimes and thus require frequent replacement. Gas-filled tubes, such as fluorescent or neon tubes, may have longer lifetimes, but operating using dangerously high voltages, are relatively expensive and include hazardous materials such as mercury. Further, both bulbs and gas-filled tubes consume substantial amounts of power.

In contrast, LEDs are relatively inexpensive, operate at low voltage, and have long operating lifetimes. Additionally, LEDs consume relatively little power, are compact, and do not include toxic substances. These attributes make LEDs particularly desirable and well suited for many applications.

Although it is known that the brightness of the light emitted by an LED can be increased by increasing the electrical current supplied to the LED, increased current also increases the junction temperature of the LED. Excessive heat reduces the efficiency and lifetime of the LED. Advances in LED technology have brought increasingly bright LEDs. However, such increased brightness is accompanied by increased heat generation.

Consequently, there exist a need for a solution for dissipating and otherwise transferring heat generated by the LEDs and their associated circuitry away from the LEDs themselves to increase the efficiency and lifetime of such products.

### BRIEF DESCRIPTION OF THE DRAWINGS

The invention will be more readily understood in view of the following description when accompanied by the below figures and wherein like reference numerals represent like elements.

FIG. 1 illustrates a front perspective view of a reflector cover in accordance with an embodiment of the disclosure;

FIG. 2 illustrates a front, top view of the reflector cover of FIG. 1;

FIG. 3 illustrates a side view of the reflector cover of FIG. 1;

FIG. 4 illustrates a cross sectional view of a reflector, a reflector fastener housing and a rigid connecting member of the reflector cover of FIG. 1;

FIG. 5 illustrates a rear perspective view of the reflector cover of FIG. 1;

FIG. 6 illustrates a front perspective view of a printed circuit board having a plurality of LED packages and a plurality of thermal vias in accordance with an embodiment of the disclosure;

FIG. 7 illustrates a front view of the printed circuit board of FIG. 6;

FIG. 8 illustrates a side view of the printed circuit board of FIG. 6;

FIG. 9 illustrates a rear perspective view of a mounting bracket in accordance with an embodiment of the disclosure;

FIG. 10 illustrates a top view of the mounting bracket of FIG. 9;

FIG. 11 illustrates a side view of the mounting bracket of FIG. 9;

FIG. 12 illustrates a rear perspective assembly view of an even pressure distribution LED illumination device in accordance with an embodiment of the disclosure;

FIG. 13 illustrates a front perspective assembled view of the even pressure distribution LED illumination device of FIG. 12;

FIG. 14 illustrates a front side perspective assembled view of the even pressure distribution LED illumination device of FIG. 13;

FIG. 15 illustrates a side perspective view of the even pressure LED illumination device of FIG. 13;

FIG. 16 illustrates a top view of a LED illumination device of FIG. 13; and

FIG. 17 illustrates an exploded top view of a reflector, LED package and the plurality of vias for the center reflector in the LED illumination device of FIG. 16.

### DETAILED DESCRIPTION

Briefly stated, the present disclosure is directed to a reflector cover for use in connection with a light emitting diode (“LED”) illumination device and an LED illumination device that includes at least a reflector cover and circuit board.

In accordance with one embodiment of the present disclosure, the reflector cover includes an open air reflector having a reflector base. The LED illumination device includes a circuit board having an LED package coupled thereto. The immediate perimeter of the LED package defines a connectivity region that includes an electrical connectivity region and a thermal connectivity region. The LED package is mechanically and electrically coupled to the electrical connectivity region and mounted atop or in the vicinity of the thermal connectivity region.

The electrical connectivity region permits the actual mechanical coupling of the LED package to the circuit board and also functions as the live portion for electron flow to the cathodes and anodes of the LED package. The thermal connectivity region, often known as the head pad or slug, is made of copper or any other suitable material that is capable of supporting thermal heat transfer. Within in the thermal connectivity region are disposed a plurality of thermal vias that extend from the top portion of the circuit board to the bottom portion of the circuit board. In operation, the thermal vias transfer heat from the LED side of the thermal connectivity region to the opposite side of the board

The reflector base is dimensioned to cover at least a portion of the thermal connectivity region thereby defining a pressure zone. The reflector cover is capable of being mechanically coupled to the circuit board such that the reflector base applies pressure to the pressure zone.

In one embodiment, the reflector cover further includes a reflector fastener housing rigidly coupled to the reflector. The reflector cover is capable of being mechanically coupled to the circuit board by mechanically coupling the reflector fastener housing to the circuit board with a fastener such as a screw.

The present disclosure is further directed to an LED illumination device that includes both a reflector cover and the circuit board as generally described above. The LED illumination device further includes a reflector fastener housing rigidly coupled to the open air reflector and a fastener such as a screw. The reflector cover is mechanically coupled to the circuit board by mechanically coupling the reflector fastener housing to the circuit board with the fastener.

The present disclosure is further directed to an LED illumination device that includes a substantially rigid reflector cover comprising a plurality of open air reflectors and a plurality of reflector fastener housings. Each open air reflector of the plurality of open air reflectors includes a reflector base. Each reflector fastener housing of the plurality of reflector fastener housings defines a reflector fastener aperture. The LED illumination device includes a circuit board having a plurality of LED packages coupled thereto. The circuit board further includes a plurality of circuit board fastener apertures disposed within the circuit board.

Each LED package of the plurality of LED packages includes an LED and an LED substrate. The immediate perimeter of the LED package defines a connectivity region as generally described above. The reflector base of each open air reflector of the plurality of open air reflectors is dimensioned to cover at least a portion of the thermal connectivity region thereby defining a pressure zone. The reflector cover is capable of being mechanically coupled to the circuit board such that the reflector bases apply pressure to the pressure zones.

The LED illumination device further includes a mounting bracket comprising a plurality of fastener receptacles. Fasteners such as screws are utilized to couple the reflector cover to the circuit board and to couple the circuit board to the mounting bracket such that each open air reflector of the plurality of open air reflectors applies pressure to a corresponding pressure zone. In particular, individual fasteners are utilized to engage a corresponding reflector fastener aperture of the plurality of reflector fastener apertures, a corresponding circuit board fastener aperture of the plurality of circuit board fastener apertures and a corresponding fastener receptacle of the plurality of fastener receptacles.

In the following detailed description, numerous specific details are set forth in order to provide a thorough understanding the present disclosure. It will be apparent to one of ordinary skill in the art, however, that these specific details need not be used to practice the present disclosure. In other instances, well-known structures, interfaces and processes have not been shown or described in detail in order to avoid obscuring the instant disclosure.

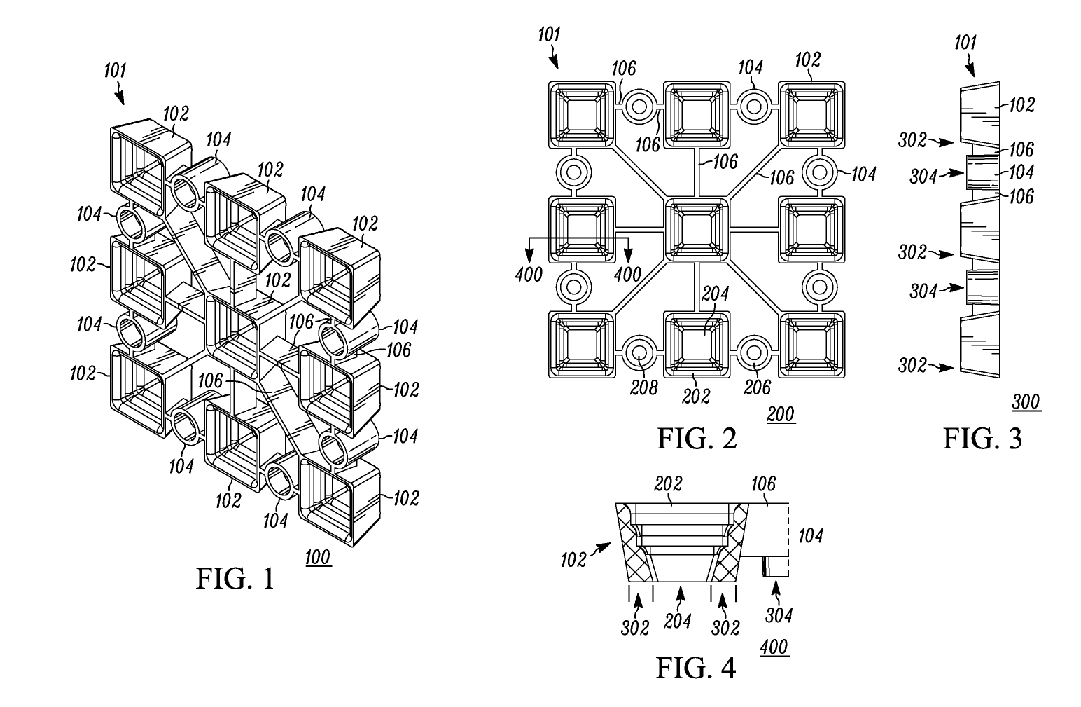

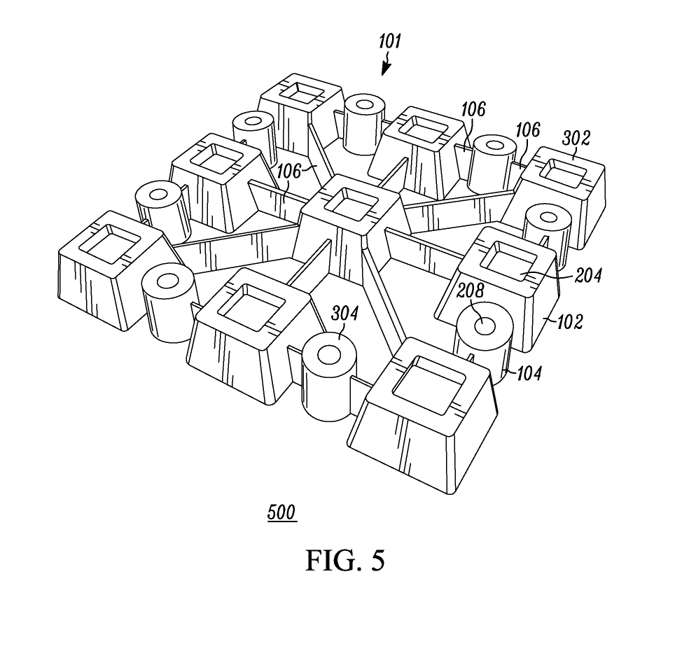

With reference to FIGS. 1-5, an exemplary reflector cover 101 in accordance with one embodiment of the present disclosure is illustrated. FIG. 1 illustrates a front perspective view 100 of reflector cover 101, FIG. 2 illustrates a front, top view 200 of reflector cover 101, FIG. 3 illustrates a side view 300 of reflector cover 101, FIG. 5 illustrates a rear perspective view 500 of reflector cover 101, and FIG. 4 illustrates a cross sectional view 400, as seen by arrows 400 in FIG. 2, of an open air reflector 102, a reflector fastener housing 104 and a rigid connecting member 106 of reflector cover 101.

As discussed in more detail below, reflector cover 101 is for use in connection with a light emitting diode (“LED”) illumination device. Reflector cover 101 includes one or more open air reflectors 102 and one or more reflector fastener housings 104. Each open air reflector 102 is rigidly coupled to either another reflector 102 or to a reflector fastener housing 104. In one embodiment, rigid connecting members 106 rigidly couple the open air reflectors 102 to the reflector fastener housings 104, thereby forming the reflector cover 101.

Each open air reflector 102 includes at least one wall 202 that defines a reflector aperture 204. The walls 202 have a thickness associated therewith, thereby establishing a reflector base 302. In one embodiment, the thickness of the walls 202 of each reflector 102 vary such that the thickness of the walls 202 is greater at the reflector base 302 than at the top of the reflector 102 (i.e., at the top of FIG. 4).

In one embodiment, the open air reflectors 102 include four side walls 202, forming a parallelogram when viewed from the top as illustrated in FIG. 2. Other shapes, however, are contemplated by the present disclosure. In one embodiment, the interior sides of the walls 202 of each open air reflector 102 form a pyramidal frustum with the base of the pyramidal frustum (i.e., the wider part) at the top of the reflector 102 (i.e., at the top of FIG. 4) and the top of the pyramidal frustum (i.e., the narrower part) at the bottom of the reflector (i.e., near the reflector base 302) as illustrated in FIG. 4. Other shapes and angles of the interior sides of the walls 202 are contemplated in the present disclosure.

Each of the plurality of reflector fastener housings 104 define a reflector fastener housing aperture 208. In one embodiment, the reflector fastener housings 104 are cylindrical housings. Other shapes, however, are contemplated by the present disclosure. The reflector fastener housings 104 also have a base 304. In one embodiment, the reflector fastener housing bases 304 are on a separate, but parallel plane as the reflector bases 302. In particular, reflector bases 302 are on a lower plane than the reflector fastener housing bases 304 (i.e., the reflector bases 302 extend past the reflector fastener housing bases 304 when the reflector cover 101 is viewed from the side as illustrated in FIG. 3).

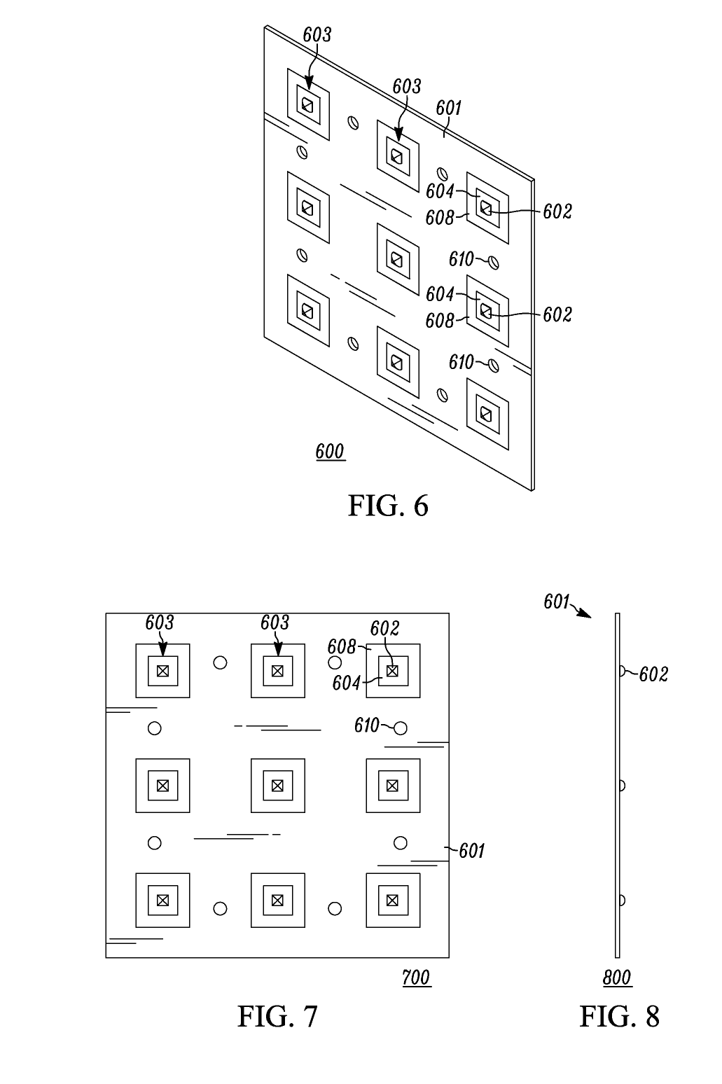

As explained in more detail below, the reflector fastener housings 104 function to permit the reflector cover 101 to be mechanically fastened to a circuit board and mounting bracket. The reflector fastener housing 104 also function to center or align the open air reflectors 102 to LEDs 602 (see FIGS. 6-17). Reflector fastener housings 104 may be dimensioned to permit the insertion and therefore engagement of a fastener such as a screw (not shown) within the reflector fastener aperture 208. In one embodiment, the reflector fastener housings 104 may be dimensioned to permit the head of a mechanical fastener to be disposed within the reflector fastener housing 104 to avoid unsightly screw heads being positioned on the outside of the reflector cover 101 (e.g., as if the fasteners were countersunk). As such, the reflector fastener housings 104 may include a flange 206 disposed within the interior walls of the reflector fastener housings 104 such that a fastener head (e.g., a screw head) can rest atop the flange 206 when engaging the reflector fastener aperture 208. The flange 206 may be formed by constructing the reflector fastener aperture 208 with walls that have a first thickness and a second thickness, where the first thickness is greater than the second thickness and where the walls are of the first thickness at the bottom portion (i.e., toward the base 302) of the reflector fastener aperture 208 and the walls are of the second thickness at the top portion of the reflector fastener aperture 208.

In one embodiment, each of the open air reflectors 102, the reflector fastener housings 104 and the rigid connecting member 106 have top portions that are on the same plane (i.e., the top portions of the open air reflectors 102, the reflector fastener housings 104 and the rigid connecting member 106 are at the same height). As previously noted, the reflector bases 302 may extend beyond the reflector fastener housing bases 304. In one embodiment, the rigid connecting members 106 may be of height that is more shallow than the reflector fastener housing bases 304 when viewed from the side and illustrated in FIG. 3. Because the rigid connecting members 106 rigidly couple the open air reflectors 102 to the reflector fastener housings 104, the reflector cover itself is substantially rigid.

Reflector cover 101, in one embodiment, is made of plastic. The plastic may be coated or painted in a reflective material to permit light from an LED to reflect off the interior walls 202 of the reflectors 102. In one embodiment, the reflector cover 101 is substantially rigid so that suitably resists being deformed. As is recognized, the reflector cover 101 is capable of being deformed under suitable conditions as described below.

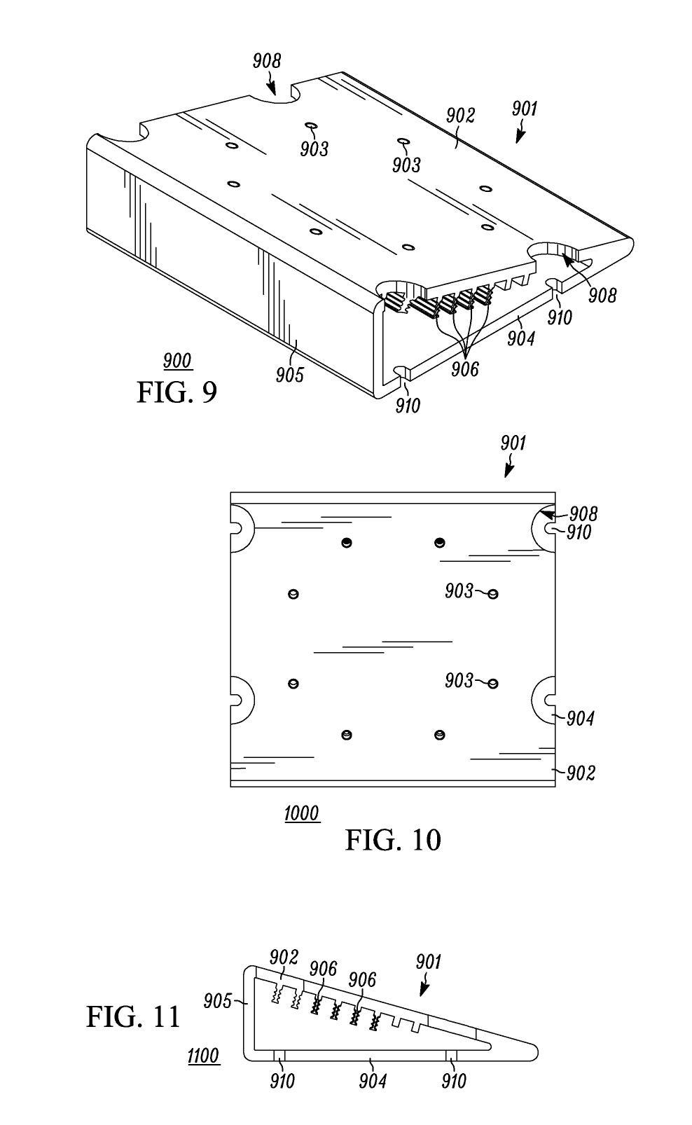

Reflector cover 101 is designed to be used in connection with a circuit board such as the printed circuit board (“PCB”) illustrated in FIGS. 6-8 and a mounting bracket such as the mounting bracket illustrated in FIGS. 9-11. In accordance with one embodiment of the disclosure, FIG. 6 illustrates a front perspective view 600 of a printed circuit board 601 having a plurality of LED packages 603 and a connectivity region 608, itself a part of the PCB 601. The connectivity region 608 includes an electrical connectivity region and a thermal connectivity region (as illustrated in FIG. 17). The LED package 603 is mechanically and electrically coupled to the electrical connectivity region and mounted atop or in the vicinity of the thermal connectivity region.

The electrical connectivity region permits the actual mechanical coupling of the LED package 603 to the PCB 601 and also functions as the live portion for electron flow to the cathodes and anodes of the LED package 603. The thermal connectivity region, often known as the head pad or slug, is made of copper or any other suitable material that is capable of supporting thermal heat transfer. Within in the thermal connectivity region are disposed a plurality of thermal vias that extend from the top portion of the PCB 601 to the bottom portion of the PCB 601. In operation, the thermal vias transfer heat from the LED side of the thermal connectivity region to the opposite side of the PCB 601. (See FIG. 17 below).

The reflector base 102 is dimensioned to cover at least a portion of the thermal connectivity region portion of the connectivity region 608, thereby defining a pressure zone. The reflector cover is capable of being mechanically coupled to the circuit board such that the reflector base applies pressure to the pressure zone.

FIG. 7 illustrates a front view 700 of PCB 601 and FIG. 8 illustrates a side view 800 of PCB 601. Each LED package 603 includes an LED 602 and an LED substrate 604. LED substrate 604 is mechanically and electrically coupled to the PCB 601, and LED 602 is mechanically and electrically coupled to the LED substrate 604, as is known in the art. PCB 601 also includes a plurality of circuit board fastener apertures 610 disposed within the PCB 601. In one embodiment, the number of circuit board fastener apertures 610 is equal to the number of reflector fastener housings 104 and the location of the circuit board fastener apertures 610 corresponds to the relative location of the reflector fastener apertures 208.

In one embodiment, the reflector bases 302 are dimensioned to cover at least a portion of the pressure zone when the reflector cover 101 is mechanically coupled to the circuit board 601. When the reflector cover 101 is mechanically coupled to the circuit board 601, as discussed below, each reflector 102 corresponds to a corresponding LED package 603. Reflectors 102 are open air reflectors that concentrate the volume of the light produced by LEDs 602 while allowing exposure of the LEDs 602 to the atmosphere. As such, reflectors 102 are not traditional optics that have a cover dimensioned to cover the LEDs 602. While such traditional optics are capable of distorting the light produced by an LED and protect the LED from external elements, they do not permit the dissipation of heat from an LED (such as LED 602) into the atmosphere.

As noted above, the thermal connectivity region and the pressure zones include a plurality of thermal vias that are formed within the circuit board 601 and that connect the top surface of the circuit board 601 to the bottom surface of the circuit board 601. Thermal vias (also known as heat pipes) may include hollow, cylindrical copper pipes and function to transfer heat from one side of the circuit board 601 to the other side of the circuit board 601.

In accordance with one embodiment of the disclosure, FIG. 9 illustrates a rear perspective view 900 of a mounting bracket 901 in accordance with an embodiment of the disclosure. FIG. 10 illustrates a top view 1000 of mounting bracket 901 and FIG. 11 illustrates a side view 1100 of mounting bracket 901. Exemplary mounting bracket 901 includes top surface 902, bottom surface 904 and side elevation surface 905 that takes the shape of a triangle when viewed from the side as illustrated in FIG. 11. In other words, the first end of the bottom surface 904 is coupled to the first end of the side elevation surface 905, the bottom surface 904 is perpendicular to the top surface 902, the second end of the bottom surface 904 is coupled to the first end of the top surface 902 and the second end of the side elevation surface 905 is coupled to the second end of the top surface 902.

The mounting bracket 901 includes a plurality of heat sinking fins 906 coupled to the bottom side of the top surface 902. Heat sinking fins 906 are preferably exposed to the atmosphere to enable heat to readily dissipate from the fins 906 into the atmosphere.

The mounting bracket 901 includes a plurality of fastener receptacles 903 disposed therein (e.g., disposed within the top surface 902). In one embodiment, the number of fastener receptacles 903 is equal in number to the number of circuit board fastener apertures 610 and the number of reflector fastener housings 104. The location of the fastener receptacles 903 corresponds to the relative locations of the circuit board fastener apertures 610 and reflector fastener apertures 208. The fastener receptacles 903 are dimensioned to engage and secure a fastener (not shown). In one embodiment, the fastener receptacles 903 are threaded.

Exemplary mounting bracket 901 may further include mounting bracket apertures 910 that are disposed within the outside edges of the bottom surface 904 of mounting bracket 901. The mounting bracket apertures 910 are dimensioned to accept a fastener (not shown) such as a screw that engages the mounting bracket aperture 910 and is therefore capable of coupling or fastening the mounting bracket 901 to another surface (not shown). In one embodiment, the mounting bracket 901 may further include corresponding surface relief portions 908 disposed within the outside edges of the top surface 902 to permit a user access to the mounting bracket apertures 901 (e.g., with a screw driver or other tool).

Other shapes of the mounting bracket 901 are contemplated. Indeed, a one-dimensional (i.e., existing in a single plane) mounting bracket may be used in place of the three-dimensional (i.e., existing in multiple planes), triangular-shaped mounting bracket 901. Similarly, other triangular-shaped mounting bracket may be utilized having a different angle of the top surface relative to the bottom surface. Mounting bracket 901 is made of metal or other suitable material capable of supporting the weight of the LED illumination device and capable of pulling heat away from the LED illumination device and dissipating such heat into the environment.

As used herein, “mounting bracket” includes any bracket, heat sink device or heat or thermal transfer plate. The above-described and illustrated mounting bracket 901 is merely exemplary and is not intended to be limiting on the present disclosure.

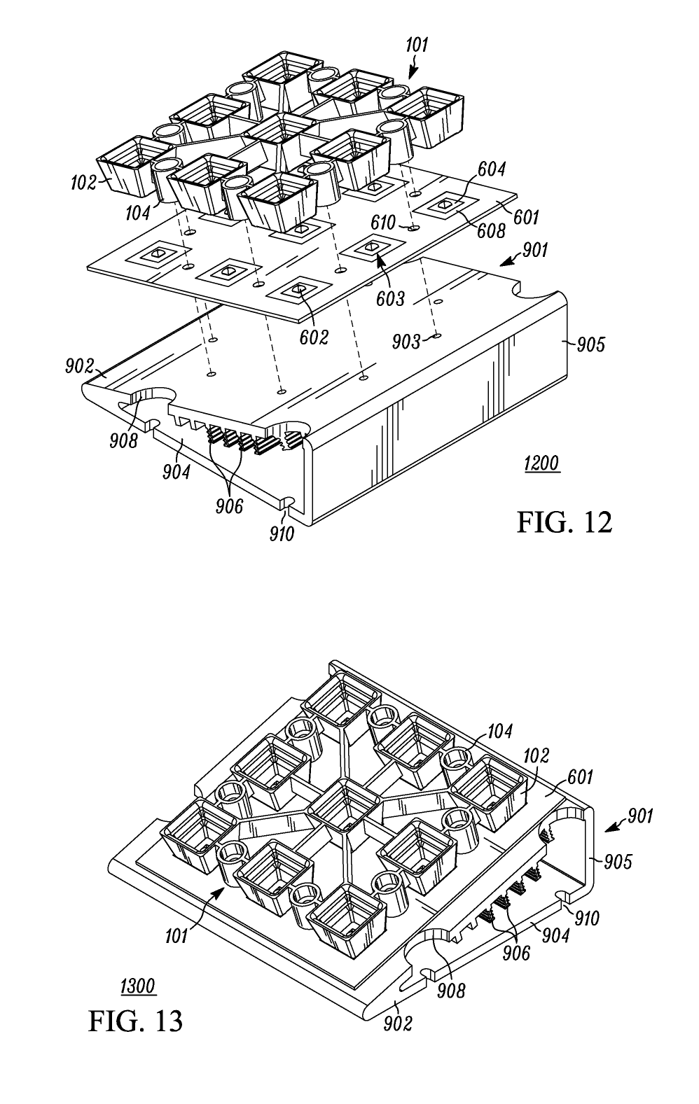

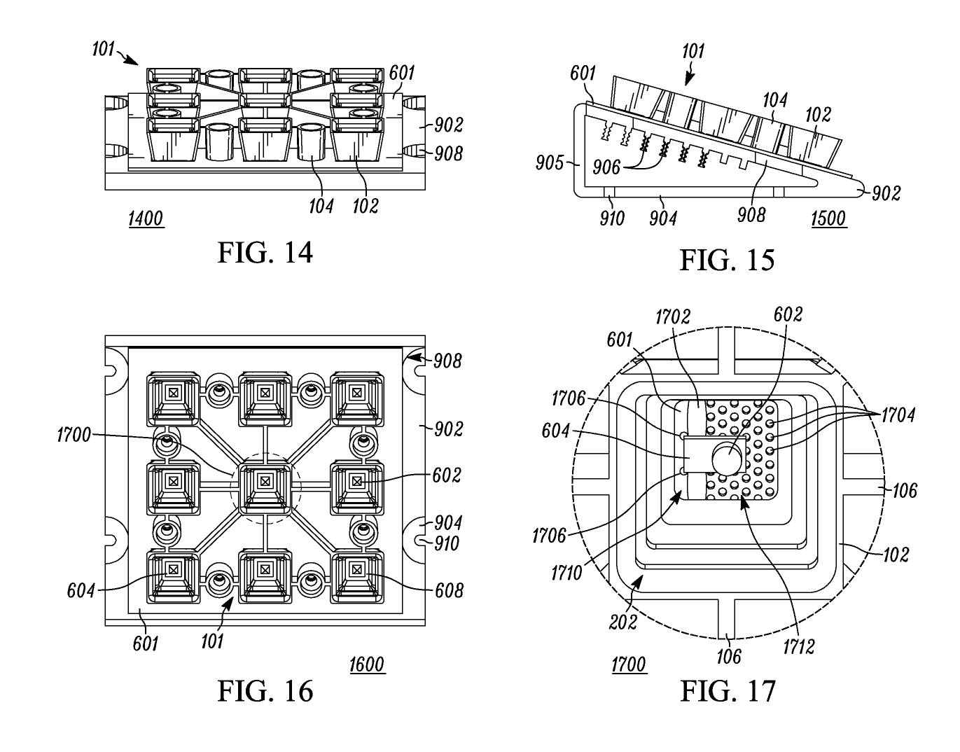

FIGS. 12-17 illustrate an LED illumination device comprising reflector cover 101, circuit board 601, and mounting bracket 901. FIG. 12 illustrates a rear perspective assembly view 1200 of the LED illumination device, FIG. 13 illustrates a front perspective assembled view 1300 of the LED illumination device, FIG. 14 illustrates a front side perspective assembled view 1400 of the LED illumination device, FIG. 15 illustrates a side perspective view 1500 of the LED illumination device, FIG. 16 illustrates a top view 1600 of the LED illumination device, and FIG. 17 illustrates an exploded top view 1700 of a reflector 102, LED package 603 and the connectivity region 608 comprising an electrical connectivity region 1710 and a thermal connectivity region 1712 for the center reflector in the LED illumination device of FIG. 16.

With reference to FIGS. 16-17, thermal connectivity region 1712 includes a plurality of vias 1704. The plurality of vias 1704 extend outward and below the base 302 of open air reflectors 102 (not illustrated in FIGS. 16-17) such that the plurality of vias 1704 within this portion of the thermal connectivity region 1712 is subject to mechanical pressure by the base 302 of the respective open air reflector 102 when the reflector cover 101, PCB 601 and mounting bracket 901 are coupled together. This portion of the plurality of thermal vias 1704 that are subject to mechanical pressure is the pressure zone.

With further reference to FIG. 17, LED package 603 includes LED substrate 604 and LED 602. LED substrate 604 may be mechanically coupled to the PCB 601, and in particular the electrical connectivity region 1710, using an adhesive 1702 and solder 1706. LED substrate 604 may be electrically coupled to the PCB 601, and in particular the electrical region 1710, using solder 1706. In particular, solder balls 1706 connect the anode and cathode of the LED substrate 604 to the electrical connectivity region 1710.

As illustrated, the reflector cover 101 is capable of being mechanically coupled to the circuit board 601 and to the mounting bracket 901. In particular, a plurality of mechanical fasteners (not shown) may be used to engage a reflector fastener aperture 208, a corresponding circuit board fastener aperture 610 and a corresponding fastener receptacle 903 (see dotted lines in FIG. 12). For example, screws (not shown) may be used to sandwich the circuit board 601 between the reflective cover 101 and the mounting bracket 901. In the process, the base 304 of each reflector fastener housing 104 is driven down into mechanical contact with the PCB 601. As each reflector fastener housing 104 is driven down into contact with PCB 601, the reflector cover 101 undergoes a slight distortion causing a significant amount of pressure to exist on the base 302 of each reflector 102 to a corresponding pressure zone. By interspersing the reflector fastener housings 104 in between reflectors 102 and by joining the reflector fastener housings 104 and the reflectors 102 using rigid connecting members 106, the reflective cover creates focused compressive-like forces or pressure on the plurality of vias 1704. In particular, downward pressure is realized at the base 302 of the plurality of reflectors 102 and upward pressure is realized at the mounting plate 901.

As a result of the foregoing, results have shown that it is possible to obtain less than a 2 degree Fahrenheit change from the top of the circuit board 601 (i.e., at the thermal connectivity region 1712) to the contact point on the mounting plate 901. By having such a small difference in temperature, thermal transfer is optimized between the LED package 603, the PCB 601 and the mounting plate 901.

An even-pressure distribution LED illumination device is contemplated in accordance with the present disclosure recognizes at least three benefits over the prior art: (1) the pressure applied to the plurality of vias 1704 creates a high rate of thermal transfer from the LED package 603 through the PCB 601 to the mounting bracket 901 (and plurality of heat sink fins 906); (2) using a reflector 102 that surrounds the LED package 603 results in a large pressure zone that not only supports a high rate of thermal transfer through the vias, but also more heat transfer at any given point in time; and (3) the open air reflectors permit the LED packages 603 to dissipate heat to the atmosphere simultaneously with the heat transfer to the mounting bracket 901 through the plurality of heat vias 1704. As such, the disclosure permits heat dissipation on both sides of the circuit board 601.

The foregoing benefits are substantial as compared to conventional LED illumination devices that use closed optics mounted to the top of a circuit board. In such conventional devices, the heat generated by the LED packages is only permitted to be pulled to the back of the circuit to a heat plate. Moreover, such conventional devices offer little or no compression of the circuit board. At best, the conventional prior art provided pressure where the optics cover attached to the circuit board, which generally corresponded to the periphery of the device (i.e., where heat dissipation is not needed) instead of the periphery of each LED package 603 The current disclosure overcomes each of these limitations by providing the foregoing even pressure distribution LED illumination device.

Other advantages will be recognized by one having ordinary skill in the art. It will also be recognized that the above description describes mere examples and that other embodiments are envisioned and covered by the appended claims. For example, it is contemplated that different patterns of reflector covers may be used to correspond to numerous different patterns of LED circuits.

What is claimed is:

1. A reflector cover for use in connection with a light emitting diode (“LED”) illumination device comprising:
an open air reflector having a reflector base, wherein:
the LED illumination device includes a circuit board having an LED package coupled thereto, at least a portion of the circuit board in the immediate vicinity of the LED package defining a pressure zone,
the reflector base is dimensioned to cover at least a portion of the pressure zone, and
the reflector cover is capable of being mechanically coupled to the circuit board such that the reflector base applies pressure to the pressure zone.

2. The reflector cover of claim 1 further comprising a reflector fastener housing rigidly coupled to the reflector, wherein the reflector cover is capable of being mechanically coupled to the circuit board by mechanically coupling the reflector fastener housing to the circuit board with a fastener.

3. The reflector cover of claim 2, further comprising at least one of:
a second open air reflector rigidly coupled to the open air reflector; and
a third open air reflector rigidly coupled to the reflector fastener housing.

4. The reflector cover of claim 1, wherein the open air reflector includes at least one wall that defines a reflector aperture.

5. The reflector cover of claim 1, wherein the open air reflector includes four side walls, wherein the interior sides of the four side walls of the open air reflector forms a pyramidal frustum.

6. The reflector cover of claim 2, wherein the reflector fastener housing has a base that is on a separate, but parallel plane as the reflector base, wherein the reflector base is on a lower plane than the reflector fastener housing base relative to the circuit board.

7. The reflector cover of claim 2, wherein:
the reflector fastener housing defines a reflector fastener aperture,
the circuit board includes a circuit board fastener aperture disposed therein, and
the fastener engages the reflector fastener aperture and the circuit board fastener aperture.

8. The reflector cover of claim 1, wherein the reflector side wall has a top side opposite the reflector base, wherein the wall thickness at the reflector base is greater than the wall thickness at the top side of the reflector wall.

9. A light emitting diode (“LED”) illumination device comprising:
an open air reflector having a reflector base; and
a circuit board having an LED package coupled thereto, at least a portion of the circuit board in the immediate vicinity of the LED package defining a pressure zone, wherein:
the reflector base is dimensioned to cover at least a portion of the pressure zone, and
the reflector cover is mechanically coupled to the circuit board such that the reflector base applies pressure to the pressure zone.

10. The LED illumination device of claim 9, further comprising:
a reflector fastener housing rigidly coupled to the open air reflector; and
a fastener, wherein the reflector cover is mechanically coupled to the circuit board by mechanically coupling the reflector fastener housing to the circuit board with the fastener.

11. The LED illumination device of claim 9, wherein:
a portion of the circuit board in the immediate vicinity of the of the LED package comprises a thermal connectivity region,
the thermal connectivity region includes a plurality of thermal vias, wherein the plurality of thermal vias are formed within the circuit board and connect a top surface of the circuit board to a bottom surface of the circuit board, and
at least a portion of the thermal connectivity region comprises the pressure zone.

12. The LED illumination device of claim 10, further comprising at least one of:
a second open air reflector rigidly coupled to the open air reflector; and
a third open air reflector rigidly coupled to the reflector fastener housing.

13. The LED illumination device of claim 9, wherein the open air reflector includes at least one wall that defines a reflector aperture.

14. The LED illumination device of claim 9, wherein the open air reflector includes four side walls, wherein the interior sides of the four side walls of the open air reflector forms a pyramidal frustum.

15. The LED illumination device of claim 10, wherein the reflector fastener housing has a base that is on a separate, but parallel plane as the reflector base, wherein the reflector base is on a lower plane than the reflector fastener housing base relative to the circuit board prior to being mechanically fastened to the circuit board.

16. The LED illumination device of claim 10, wherein:
the reflector fastener housing defines a reflector fastener aperture,
the circuit board includes a circuit board fastener aperture disposed therein, and
the fastener engages the reflector fastener aperture and the circuit board fastener aperture.

17. The LED illumination device of claim 9, wherein the reflector side wall has a top side opposite the reflector base, wherein the wall thickness at the reflector base is greater than the wall thickness at the top side of the reflector wall.

18. The LED illumination device of claim 9, wherein each LED package of the plurality of LED packages comprises an LED and an LED substrate.

19. The LED illumination device of claim 9, further comprising a mounting bracket mechanically coupled to a bottom surface of the circuit board.

20. The LED illumination device of claim 16, further comprising a mounting bracket including a fastener receptacle, wherein the fastener engages the fastener receptacle, thereby mechanically coupling the mounting bracket to the bottom surface of the circuit board.

21. The LED illumination device of claim 19, wherein the mounting bracket comprises a plurality of heat sinking fins located on a bottom side of the top surface.

22. The LED illumination device of claim 21, wherein the mounting bracket further comprises:
a bottom surface having a first end and a second end;
a top surface having a first end and a second end; and
and a side elevation surface having a first end and a second end, wherein:
the first end of the bottom surface is coupled to the first end of the side elevation surface,
the bottom surface and the side elevation surface are perpendicular to each other,
the second end of the bottom surface is coupled to the first end of the top surface, and
the second end of the side elevation surface is coupled to the second end of the top surface.

23. The LED illumination device of claim 19, wherein the mounting bracket is made of a metal.

24. A light emitting diode (“LED”) illumination device comprising:
a substantially rigid reflector cover comprising a plurality of open air reflectors and a plurality of reflector fastener housings, wherein:
each open air reflector of the plurality of open air reflectors includes a reflector base, and
each reflector fastener housing of the plurality of reflector fastener housings defines a reflector fastener aperture;
a circuit board including a plurality of LED packages coupled thereto and further including a plurality of circuit board fastener apertures disposed within the circuit board, wherein:
each LED package of the plurality of LED packages comprises an LED and an LED substrate,
a portion of the circuit board in the immediate vicinity of the of the LED package comprises a thermal connectivity region,
the thermal connectivity region includes a plurality of thermal vias, wherein the plurality of thermal vias are formed within the circuit board and connect a top surface of the circuit board to a bottom surface of the circuit board,
at least a portion of the thermal connectivity region comprises the pressure zone, and
the reflector base of each open air reflector of the plurality of open air reflectors is dimensioned to cover at least a portion of a corresponding pressure zone;
a mounting bracket comprising a plurality of fastener receptacles; and
a plurality of fasteners, each fastener of the plurality of fasteners engaging a corresponding reflector fastener aperture of the plurality of reflector fastener apertures, a corresponding circuit board fastener aperture of the plurality of circuit board fastener apertures and a corresponding fastener receptacle of the plurality of fastener receptacles, thereby coupling the reflector cover to the circuit board and coupling the circuit board to the mounting bracket such that the each open air reflector of the plurality of open air reflectors applies pressure to a corresponding pressure zone.
